(19) United States
(12) Patent Application Publication
(10) Pub. No.: US 2019/0064707 A1
(43) Pub. Date: Feb. 28, 2019

(54) IMAGE FORMING APPARATUS

(71) Applicant: CANON KABUSHIKI KAISHA, Tokyo (JP)

(72) Inventors: Michihiro Yoshida, Nagareyama-shi (JP); Takayuki Suzuki, Kashiwa-shi (JP); Tadashi Iwakawa, Tokyo (JP)

(21) Appl. No.: 16/107,921

(22) Filed: Aug. 21, 2018

(30) Foreign Application Priority Data
Aug. 25, 2017 (JP) 2017-161729
Jun. 4, 2018 (JP) 2018-107033

(51) Int. Cl. G03G 15/16; G03G 15/04; G03G 15/08; G03G 15/02

(52) U.S. Cl. CPC G03G 15/1615; G03G 15/0225; G03G 15/0865; G03G 15/04

(57) ABSTRACT

An image forming apparatus includes a photosensitive drum, a driving source for driving the photosensitive drum, a charging roller, a cleaning roller for cleaning the charging roller, a bearing member having an space which allows the charging roller to be moved to a first position in which the charging roller is in contact with the cleaning roller and the photosensitive drum and a second position in which the charging roller is separated from the cleaning roller and is in contact with the photosensitive drum, and a biasing member which biases the bearing member.

### BACKGROUND OF THE INVENTION

### Field of the Invention

The present disclosure relates to electrophotographic image forming apparatuses applicable to copying machines, laser printers, facsimile machines, printing devices, and multi-function peripherals thereof.

### Description of the Related Art

A charging roller that charges a photosensitive drum by coming into contact with the photosensitive drum is widely used as a charging device of an image forming apparatus. External additives (silica, etc.) of toners can cause uneven charging when they adhere to the surface of the charging roller, so that a charging roller cleaning member is conventionally used to remove substances attached to the charging roller.

Further, there are cases in which the charging roller cleaning member contains oil such as silicone-based oil, and if the charging roller cleaning member remains in contact with the charging roller for a long time, the oil is moved onto the charging roller. This changes the surface resistance of the contact portion of the charging roller to cause image defects originating from charging roller pitch.

Japanese Patent Application Laid-Open No. 10-39584 discusses a technique for mechanically moving a charging roller cleaning member to a charging roller and separating the charging roller cleaning member from the charging roller. Further, Japanese Patent Application Laid-Open No. 2011-22482 discusses a technique for making image defects less visible by rotating a charging roller for a predetermined time corresponding to a continuous contact time of the charging roller with a charging roller cleaning member to average the surface resistance of the charging roller.

However, the technique discussed in Japanese Patent Application Laid-Open No. 10-39584 cannot realize initial cost reduction and size reduction because the technique requires a space for a mechanism of bringing the charging roller cleaning member and the charging roller into contact with each other and separating the charging roller cleaning member and the charging roller from each other and also requires a driving source separately.

Further, the technique discussed in Japanese Patent Application Laid-Open No. 2011-22482 rotates the charging roller for a predetermined time while the image forming is paused, so that the productivity in image forming decreases.

### SUMMARY OF THE INVENTION

The present disclosure is directed to an image forming apparatus capable of bringing a charging roller and a cleaning member for cleaning the charging roller into contact with each other and separating the charging roller and the cleaning member from each other using a simplified structure without a dedicated driving source to realize reduced cost and space.

According to an aspect of the present disclosure, an image forming apparatus includes a photosensitive drum which is rotatable, a driving source which rotates the photosensitive drum, a charging roller which includes a rotation shaft, is brought into contact with the photosensitive drum to be rotated in association with rotation of the photosensitive drum, and charges the photosensitive drum as a voltage is applied, a cleaning roller which is brought into contact with the charging roller to be rotated in association with rotation of the charging roller and cleans a substance attached to the charging roller, an image forming unit which forms an image by forming a toner image on the photosensitive drum charged by the charging roller and transferring the toner image onto a recording material, a bearing member which has a space in which the rotation shaft is movable, and bears the rotation shaft on an inner circumferential surface of the space, wherein the space allows the charging roller to be moved to a first position in which the charging roller is in contact with the cleaning roller and the photosensitive drum and a second position in which the charging roller is separated from the cleaning roller and is in contact with the photosensitive drum, the area including an inner surface which bears the rotation shaft, and a biasing member which biases the bearing member toward the photosensitive drum.

Further features of the present disclosure will become apparent from the following description of exemplary embodiments with reference to the attached drawings.

### BRIEF DESCRIPTION OF THE DRAWINGS

FIG. 1 illustrates a configuration of an image forming apparatus according to an embodiment of the present disclosure.

FIG. 2 illustrates a configuration of an image forming station according to an embodiment of the present disclosure.

FIG. 3 illustrates a configuration of a charging roller, a cleaning roller, a photosensitive drum, and a bearing according to an embodiment of the present disclosure.

FIG. 4 illustrates force applied to the charging roller in a charging position while the photosensitive drum is rotated in a first exemplary embodiment.

FIG. 5 illustrates force applied to the charging roller in the charging position while the photosensitive drum is stopped in the first exemplary embodiment.

FIG. 6 illustrates force applied to the charging roller in a retracted position while the photosensitive drum is rotated in the first exemplary embodiment.

FIG. 7 illustrates force applied to the charging roller while the photosensitive drum is rotated in a positive direction in a second exemplary embodiment.

FIG. 8 illustrates force applied to the charging roller in the charging position while the photosensitive drum is rotated in an opposite direction in the second exemplary embodiment.

FIG. 9 illustrates force applied to the charging roller in the retracted position while the photosensitive drum is rotated in the positive direction in the second exemplary embodiment.

FIG. 10 schematically illustrates a control block of the image forming apparatus according to an embodiment of the present disclosure.

FIG. 11 is a flowchart illustrating a process of control in image forming in the second exemplary embodiment.

### DESCRIPTION OF THE EMBODIMENTS

Various exemplary embodiments of the present disclosure will be described below with reference to the drawings. It should be noted that the dimensions, materials, shapes, relative positions, etc. of components that are described in the exemplary embodiments are to be changed as needed depending on the structure of an apparatus and various conditions and are not intended to limit the scope of the disclosure.

### <Image Forming Apparatus>

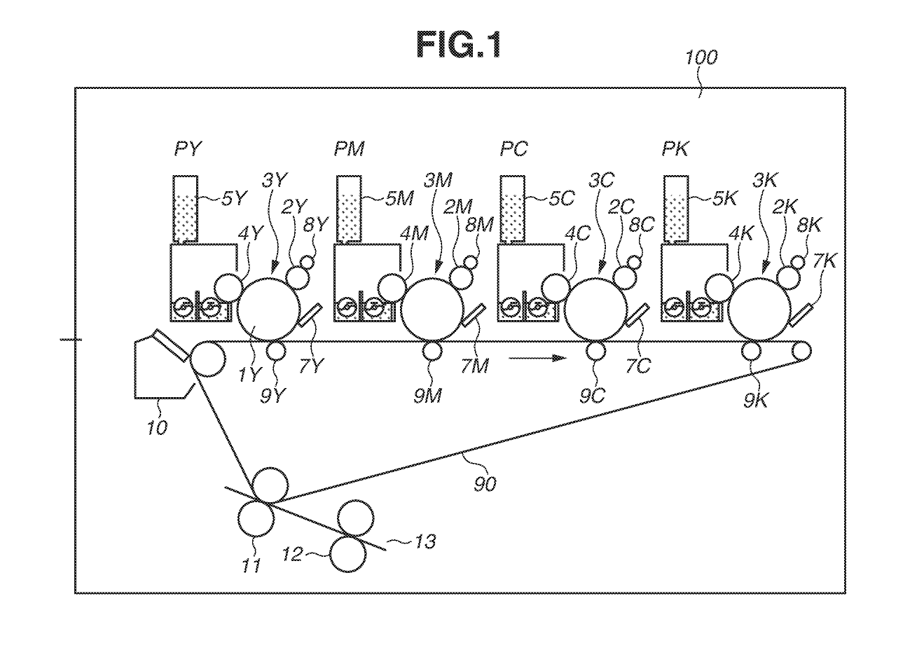

A first exemplary embodiment will be described below. FIG. 1 illustrates a configuration of an image forming apparatus according to the first exemplary embodiment. An image forming apparatus 100 is a tandem full-color printer of an intermediate transfer method and includes an intermediate transfer belt 90 and yellow, magenta, cyan, and black image forming stations PY, PM, PC, and PK disposed along the intermediate transfer belt 90.

At the image forming station PY, a yellow toner image is formed on a photosensitive drum 1Y and transferred onto the intermediate transfer belt 90. At the image forming station PM, a magenta toner image is formed on a photosensitive drum 1M and transferred onto the intermediate transfer belt 90. At the image forming stations PC and PK, a cyan toner image and a black toner image are respectively formed on photosensitive drums 1C and 1K and transferred onto the intermediate transfer belt 90.

As the intermediate transfer belt 90 is rotated, a full-color toner image formed by superimposing the toner images of the four colors is conveyed to a secondary transfer portion 11 and secondarily transferred onto a recording material 13.

The recording materials 13 conveyed from a recording material cassette (not illustrated) are separated one by one by the secondary transfer portion 11 and conveyed to a registration roller 12.

The registration roller 12 sends out the recording material 13 to the secondary transfer portion 11 to synchronize the timing of the toner image on the intermediate transfer belt 90.

An image forming unit 301 formed by the image forming stations PY, PM, PC, and PK and the secondary transfer portion 11 forms an image by forming toner images on the photosensitive drums charged by a charging roller and then transferring the toner images onto a recording material.

The photosensitive drum 1Y is rotatable by a driving source (motor) 300.

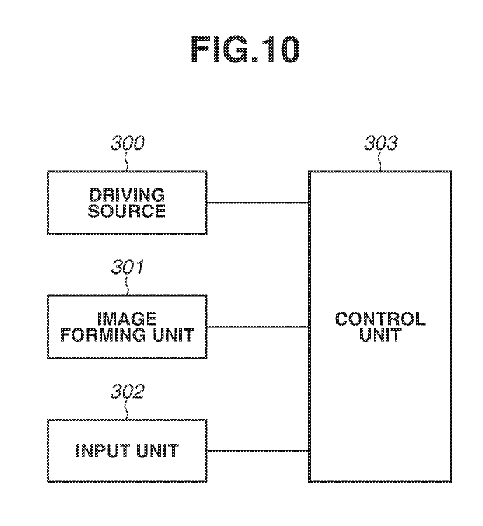

FIG. 10 schematically illustrates a control block of the image forming apparatus 100. A control unit 303 receives signals from an input unit 302 to which image forming instructions are input from an external device or an operation unit (not illustrated) provided to the image forming apparatus 100, and controls the driving source 300 and the image forming unit 301.

The recording material 13 with a full-color toner image formed thereon by the secondary transfer at the secondary transfer portion 11 is heated and pressed by a fixing device (not illustrated) to fix the image to the surface of the recording material 13 and then discharged outside the image forming apparatus 100.

The image forming stations PY, PM, PC, and PK have substantially the same structure except that the colors of toners used by development devices 4Y, 4M, 4C, and 4K are different.

The following describes the image forming station PY, and the description of the image forming station PY also applies to the image forming stations PM, PC, and PK by replacing “Y” at the end of each reference character of the components of the image forming station PY with M, C, and K, respectively.

### <Schematic Structure of Image Forming Station>

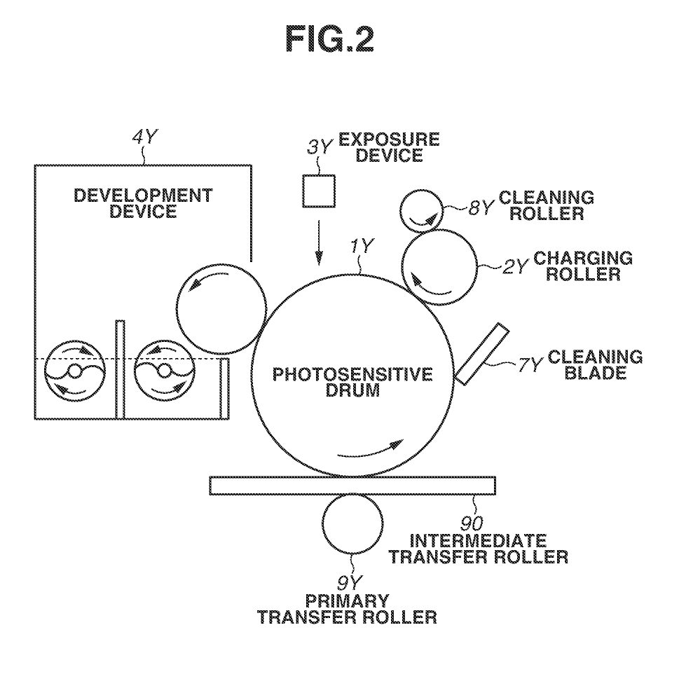

FIG. 2 illustrates the structure of the image forming station (PY). The image forming station PY includes a charging roller 2Y, a the cleaning roller 8Y, an exposure device 3Y, the development device 4Y, a cleaning blade 7Y, and a primary transfer roller 9Y which are disposed around the photosensitive drum 1Y. The other image forming stations PM, PC, and PK have a similar structure to that of the image forming station PY, so that description thereof is omitted.

Examples of a material that can be used as a material of the outer surface of the photosensitive drum 1Y include phenolic resins, acrylic resins, and methacrylic resins.

The charging roller 2Y includes a rotation shaft (metal core) 21Y borne by a bearing 23Y (bearing member), and the bearing 23Y is biased to bring the charging roller 2Y into contact with the photosensitive drum 1Y. The charging roller 2Y is rotated in association with the rotation of the photosensitive drum 1Y and charges the photosensitive drum 1Y as a voltage is applied.

Examples of a material that can be used as a material of the outer surface of the charging roller 2Y include resins such as thermosetting resins and thermoplastic resins and, as a binder, fluorine resins, polyamide resins, acrylic resins, polyurethane resins, and silicone resins can be used.

Further, a metal such as iron, copper, aluminum, or nickel or an alloy thereof (stainless steel, brass, bronze, etc.) can be used as a material of the rotation shaft 21Y of the charging roller 2Y.

The cleaning roller 8Y is brought into contact with the charging roller 2Y and rotated in association with the rotation of the charging roller 2Y to clean substances attached to the charging roller 2Y. A porous material such as a polystyrene-based elastomer, a polyolefin-based elastomer, or a polyurethane-based elastomer can be used as a material of the outer surface of the cleaning roller 8Y.

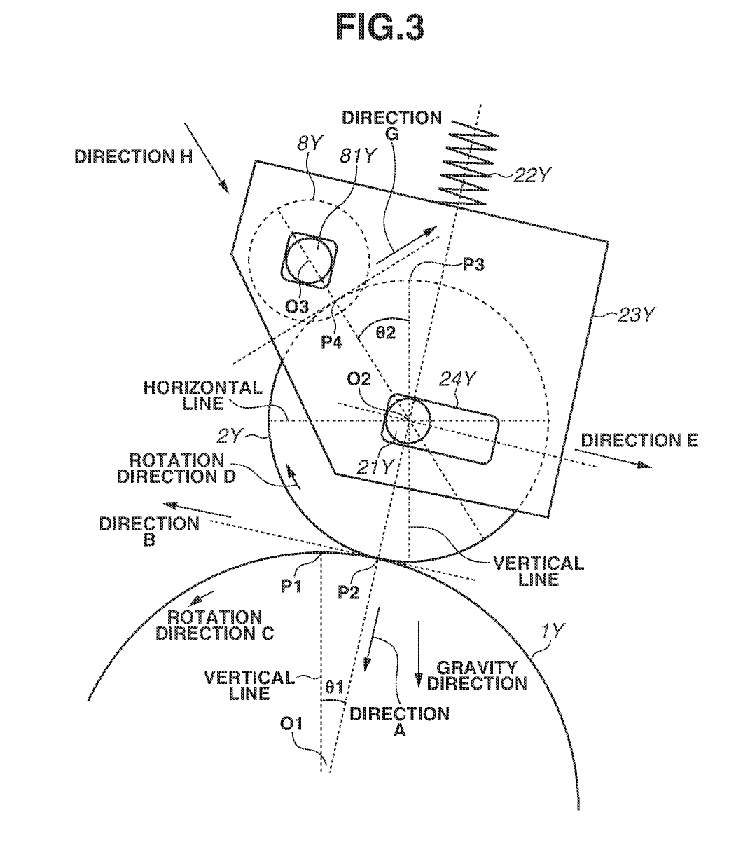

FIG. 3 illustrates the charging roller 2Y, the cleaning roller 8Y, the photosensitive drum 1Y, and the bearing 23Y viewed from a rotation axial direction of the charging roller 2Y in the case in which the charging roller 2Y is located in a first position which is a position at the time of image forming. In FIG. 3, the charging roller 2Y is in contact with the photosensitive drum 1Y at a charging contact portion and is in contact with the cleaning roller 8Y at a cleaning contact portion.

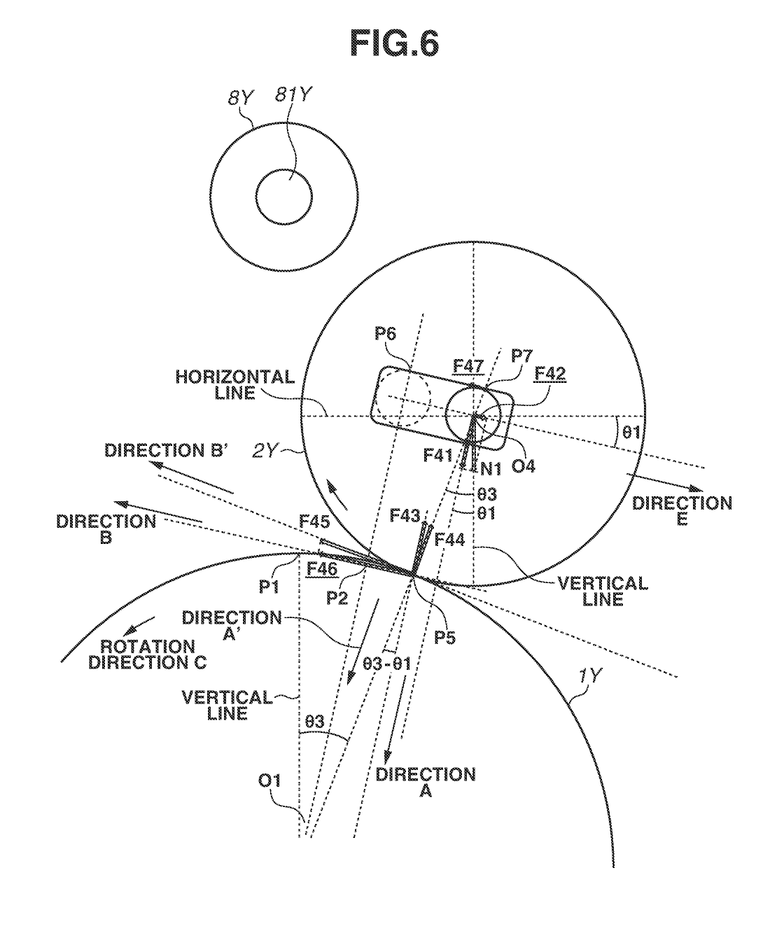

FIG. 6 illustrates the charging roller 2Y, the cleaning roller 8Y, and the photosensitive drum 1Y viewed from the rotation axial direction of the charging roller 2Y in the case in which the charging roller 2Y is in a second position in which the charging roller 2Y is separated from the cleaning roller 8Y. In FIG. 6, the charging roller 2Y is in contact with the photosensitive drum 1Y and is separated from the cleaning roller 8Y. The second position is located lower than the first position in the vertical direction.

The bearing 23Y rotatably bears, on the inner circumferential surface thereof, a metal core 21Y of the charging roller 2Y at one of the end portions of the charging roller 2Y in the lengthwise direction of the charging roller 2Y. A resin material such as polyacetal (POM), polyethylene (PE), or polyethylene terephthalate (PET) is used as a material of the bearing 23Y, and the inner circumferential surface of the bearing 23Y is also made of the same material. Further, the bearing 23Y rotatably bears a metal core (cleaning roller rotation shaft) 81Y of the cleaning roller 8Y and bears the metal core 21Y of the charging roller 2Y on the inner circumferential surface of a bearing hole 24Y in a movable state.

Further, the position of the rotation center of the metal core 81Y is fixed with respect to the bearings 23Y except for minor gaps. Alternatively, the metal core 81Y can be borne by a member other than the bearing 23Y.

The bearing 23Y has the bearing hole 24Y which is a space where the metal core 21Y of the charging roller 2Y is movable to allow the charging roller 2Y to be moved to a position including the first and second positions, and the bearing 23Y bears the metal core 21Y of the charging roller 2Y.

Space is formed by the inner circumferential surface of the bearing hole 24Y such that the metal core 21Y of the charging roller 2Y is movable in the space, and the inner circumferential surface forming the space has a rectangular shape (elongated hole shape) with the longer sides extending in the movement direction of the metal core 21Y when viewed from the rotation axial direction of the charging roller 2Y. Further, on part of the inner circumferential surface of the bearing hole 24Y, a contacted portion where the metal core 21Y of the charging roller 2Y contacts is formed in a direction intersecting with the direction in which the longer sides extend, such that the charging roller 2Y is disposed in the first position while receiving a rotation force from the photosensitive drum.

The bearings 23Y at the respective end portions of the charging roller 2Y in the lengthwise direction are configured such that the bearings 23Y can collectively or independently be moved to or away from the photosensitive drum 1Y.

A spring 22Y (biasing member) biases the bearing 23Y toward the photosensitive drum 1Y.

In FIG. 3, “O1” denotes the rotation center of the photosensitive drum 1Y, “O2” denotes the rotation center of the charging roller 2Y when the charging roller 2Y is in the first position, and “O3” denotes the rotation center of the cleaning roller 8Y.

Further, “P1” denotes a point at which a vertical line passing through the rotation center O1 intersects with the outer circumferential surface of the photosensitive drum 1Y, and the point P1 lies on the upper side of the rotation center O1 in the vertical direction, and “P2” denotes a point at which the straight line connecting the rotation centers O1 and O2 intersects with the outer circumferential surface of the photosensitive drum 1Y.

Further, “P3” denotes a point at which a vertical line passing through the rotation center O2 intersects with the outer circumferential surface of the charging roller 2Y, and the point P3 lies on the upper side of the rotation center O2 in the vertical direction.

Further, “P4” denotes a point at which a straight line connecting the rotation centers O2 and O3 intersects with the outer circumferential surface of the charging roller 2Y when the charging roller 2Y is in the first position.

The point P2 is located at a position where the point P1 is rotated by an angle θ1 in the opposite rotation direction to the rotation direction of the charging roller 2Y.

The point P4 is located at a position where the point P3 is rotated by an angle θ2 in the opposite rotation direction to the rotation direction of the charging roller 2Y.

Further, in FIG. 6, “O4” denotes the rotation center of the charging roller 2Y when the charging roller 2Y is in the second position, and “P5” denotes a point at which the straight line connecting the rotation centers O1 and O4 intersects with the outer circumferential surface of the photosensitive drum 1Y.

The point P5 is located at a position where the point P1 is rotated by an angle θ3 in the opposite rotation direction to the rotation direction of the photosensitive drum 1Y.

In FIG. 6, the position at which the charging roller 2Y is in contact with the photosensitive drum 1Y when the charging roller 2Y is in the first position is the point P2. The position at which the charging roller 2Y is in contact with the photosensitive drum 1Y when the charging roller 2Y is in the second position is the point P5. The point P2 is located adjacent to the point P5 on the downstream of the point P5 in the rotation direction of the photosensitive drum 1Y.

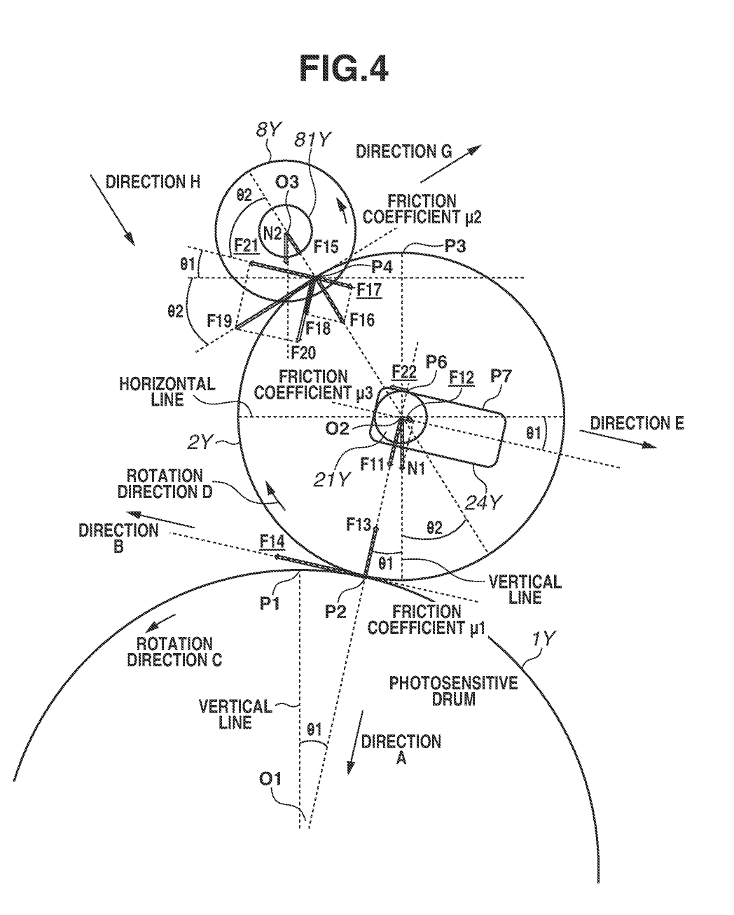

In FIG. 4, “P6” denotes a point at which the rotation shaft 21Y is in contact with the inner circumferential surface of the space when the charging roller 2Y is in the first position, and the point P6 is located on the spring 22Y side (biasing member side). “P7” denotes a point at which the rotation shaft 21Y is in contact with the inner circumferential surface of the space when the charging roller 2Y is in the second position, and the point P7 is located on the spring 22Y side (biasing member side).

Further, “direction H” denotes a direction of the straight line extending from the rotation center O3 toward the rotation center O2, “direction A” denotes a direction of the straight line extending from the rotation center O2 toward the rotation center O1, “rotation direction C” denotes a direction in which the photosensitive drum 1Y is rotated during image forming, and “rotation direction D” denotes a direction in which the charging roller 2Y is rotated in association with the rotation of the photosensitive drum 1Y during image forming.

Further, “direction B” denotes a direction that is orthogonal to the direction A and in which a tangent line that is tangent to the outer circumferential surface of the photosensitive drum 1Y at the point P2 extends toward the downstream side in the rotation direction C.

Further, “direction E” denotes a direction of the straight line extending from the point P6 toward the point P7, and “direction G” denotes a direction that is orthogonal to the direction H and goes toward a downstream side of the point P4 in the rotation direction D.

Further, “direction A′” denotes a direction of the straight line from the rotation center O4 toward the rotation center O1, and “direction B′” denotes a direction that is orthogonal to the direction A′ and in which a tangent line that is tangent to the outer circumferential surface of the photosensitive drum 1Y at the point P5 extends toward the downstream side in the rotation direction C.

### <Force Applied to Charging Roller in Charging Position While Photosensitive Drum is Rotated>

Next, force applied to the charging roller 2Y in the charging position while the photosensitive drum 1Y is rotated will be described below with reference to FIG. 4.

The control unit 303 controls the driving source 300 to rotate the photosensitive drum 1Y in the rotation direction C (rotation in the positive direction) at the time of image forming.

The charging roller 2Y is brought into contact with the photosensitive drum 1Y and is driven and rotated in the rotation direction D in association with the rotation of the photosensitive drum 1Y in the rotation direction C.

Further, the cleaning roller 8Y is brought into contact with the charging roller 2Y at the cleaning contact portion and is driven and rotated by force FG in the direction G in association with the rotation of the charging roller 2Y.

While the direction in which the spring 22Y biases the bearing 23Y is described as being parallel to the direction A as an example in the first exemplary embodiment, the configuration is not limited to the above-described example. As used herein, the phrase “being parallel” means that an angle formed by two directions is within the range of 0±3 degrees.

While the directions E and A are described to be orthogonal to each other as an example in the first exemplary embodiment, the configuration is not limited to the above-described example in which the directions E and A are orthogonal to each other. As used herein, the phrase “being orthogonal” means that an angle formed by two directions is within the range of 90±3 degrees.

Further, “N1” denotes force generated due to the mass of the charging roller 2Y, and “N2” denotes force generated due to the mass of the cleaning roller 8Y.

Further, “μ1” denotes the coefficient of friction between the outer circumferential surface of the charging roller 2Y and the outer circumferential surface of the photosensitive drum 1Y, “μ2” denotes the coefficient of friction between the outer circumferential surface of the charging roller 2Y and the outer circumferential surface of the cleaning roller 8Y, and “μ3” denotes the coefficient of friction between the outer circumferential surface of the metal core 21Y of the charging roller 2Y and the inner circumferential surface of the bearing hole 24Y.

The friction coefficients are dynamic friction coefficients. For example, the friction coefficient μ1 is measured by setting force Ns1 to a predetermined value and measuring the load torque of the rotation shaft when the photosensitive drum 1Y is rotated in a state where the charging roller 2Y is fixed.

Further, “Ns1” denotes force with which the spring 22Y biases the charging roller 2Y located in the first position toward the photosensitive drum 1Y, and “Ns1′” denotes force with which the spring 22Y biases the charging roller 2Y located in the second position toward the photosensitive drum 1Y.

Further, “Ns2” denotes a pressing force with which the cleaning roller 8Y presses the charging roller 2Y located in the first position.

A condition for locating the charging roller 2Y, which is rotated in association with the rotation of the photosensitive drum 1Y, in the first position is that force FB applied to the charging roller 2Y in the direction B is greater than force FE applied to the charging roller 2Y in the direction E. This is expressed by the following formula:

FB>FE (formula 1).

The motor which serves as a driving source applies force to the photosensitive drum 1Y such that the photosensitive drum 1Y rotates in the rotation direction C. In FIG. 4,

FB=F14+F21+F22=μ1(Ns1+N1 cos θ1+(N2 cos θ2+Ns2)cos(θ1+θ2)+μ2(N2 cos θ2+Ns2)sin(θ1+θ2))+μ3Ns1, and

FE=F12+F17=(N2 cos θ2+Ns2)cos θ2+N1 sin θ1,

i.e.,

μ1(Ns1+N1 cos θ1+(N2 cos θ2+Ns2)cos(θ1+θ2)+μ2(N2 cos θ2+Ns2)sin(θ1+θ2))+μ3Ns1>(N2 cos θ2+Ns2)cos θ2+N1 sin θ1,

need to be satisfied, where
F11 represents the component of the force N1 in the direction A,
F12 represents the component of the force N1 in the direction E,
F13 represents the reaction force of the resultant force of the force Ns1 and the components F11, F18, and F20,
F14 represents the friction force generated by the reaction force F13 and the friction coefficient μ1,
F15 represents the component of the force N2 in the direction H,
F16 represents the resultant force of the component F15 and the pressing force Ns2,
F17 represents the component of the resultant force F16 in the direction E,
F18 represents the component of the resultant force F16 in the direction A,
F19 represents the friction force generated by the resultant force F16 and the friction coefficient μ2,
F20 represents the component of the friction force F19 in the direction A,
F21 represents the component of the friction force F19 in the direction B, and
F22 represents the friction force generated by the force Ns1 and the friction coefficient μ3.
While the directions A and E are orthogonal to each other in the present exemplary embodiment, the direction in which the spring 22Y biases the bearing 23Y and the direction in which the longer sides of the area of the bearing hole 24Y extend do not have to be orthogonal to each other.

As an example of the configuration of the present exemplary embodiment, the diameter of the outer circumferential surface portion of the charging roller 2Y is set to 14 (mm), the diameter of the outer circumferential surface portion of the cleaning roller 8Y is set to 11 (mm), and the diameter of the outer surface portion of the photosensitive drum 1Y is set to 30 (mm). Further, the force N1 generated due to the mass of the charging roller 2Y is N1=1.96 (N), the force N2 generated due to the mass of the cleaning roller is N2=0.98 (N), the angle θ1=15 (degrees), the angle θ2=30 (degrees), and the angle θ3=20 (degrees).

Further, the friction coefficient μ1=2.0, the friction coefficient μ2=0.3, the friction coefficient μ3=0.3, the force Ns1=4.9 (N), the pressing force Ns2=2.35 (N), and the force Ns1′=4.41 (N). The distance between the rotation center of the charging roller 2Y located in the charging position and the rotation center of the cleaning roller 8Y is 11.5 (mm).

Since the left side of formula (1) is equal to 20.9 (N) and the right side of formula (1) is equal to 3.28 (N), it is understood that the condition of formula (1) is satisfied.

Accordingly, it is understood that the charging roller 2Y in the present exemplary embodiment is located in the first position.

### <Force Applied to Charging Roller in Charging Position While Photosensitive Drum is Stopped>

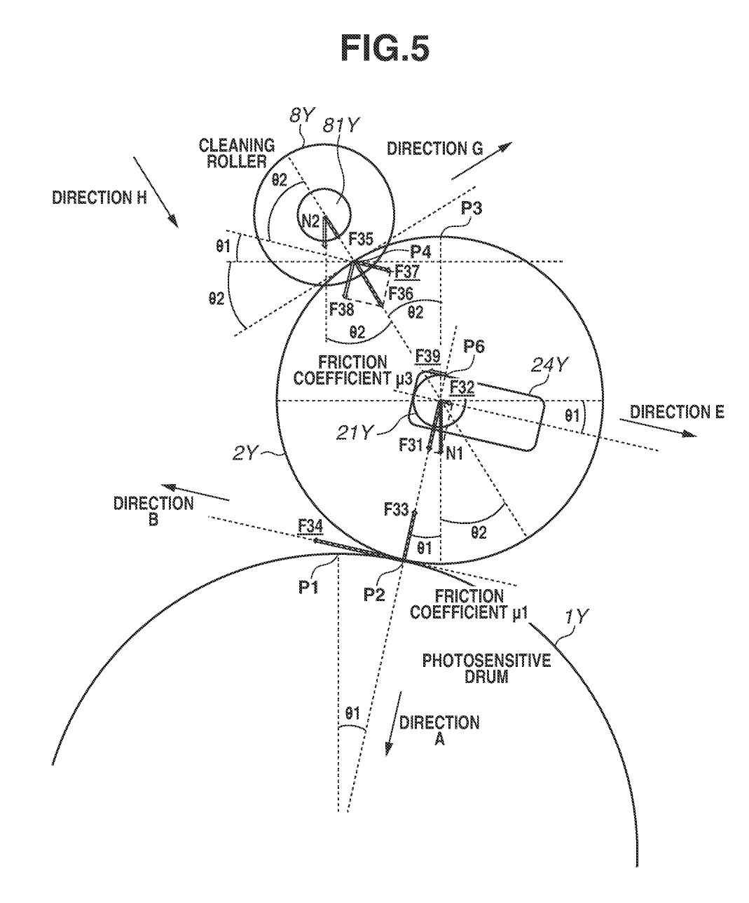

Next, force applied to the charging roller 2Y in the charging position while the photosensitive drum 1Y is stopped will be described below with reference to FIG. 5.

A condition for separating the charging roller 2Y from the cleaning roller 8Y while the photosensitive drum 1Y is stopped is that the force FE applied to the charging roller 2Y in the direction E is greater than the force FB′ (friction force applied to the metal core 21Y of the charging roller 2Y from the bearing hole 24Y) applied to the charging roller 2Y in the direction B.

In FIG. 5,

F31 represents the component of the force N1 in the direction A,
F32 represents the component of the force N1 in the direction E,
F33 represents the reaction force of the resultant force of the force Ns1 and the components F31 and F38,
F34 represents the friction force generated by the reaction force F33 and the friction coefficient μ1,
F35 represents the component of the force N2 in the direction H,
F36 represents the resultant force of the component F35 and the pressing force Ns2,
F37 represents the component of the resultant force F36 in the direction E,
F38 represents the component of the resultant force F36 in the direction A, and
F39 represents the friction force generated by the force Ns1 and the friction coefficient μ3.
After the charging roller 2Y is separated from the cleaning roller 8Y, the biasing force from the cleaning roller 8Y to the charging roller 2Y is no longer exerted, so that the values F37 and F38 are zero in the following calculation.

This is expressed by FE>FB (formula 2), where

FE=F32=N1 sin θ1, and

FB=F39=μ3×Ns1.

Since FE=3.28 (N) and FB=1.47 (N), it is understood that the condition of formula (2) is satisfied.

### <Force Applied to Charging Roller in Retracted Position While Photosensitive Drum is Rotated>

Next, force applied to the charging roller 2Y in the retracted position while the photosensitive drum 1Y is rotated will be described below with reference to FIG. 6.

A condition for moving the charging roller 2Y from the second position to the first position is that the force FB received by the charging roller 2Y in the direction B is greater than the force FE received by the charging roller 2Y in the direction E.

In FIG. 6,

F41 represents the component of the force N1 in the direction A,
F42 represents the component of the force N1 in the direction E,
F43 represents the reaction force of the resultant force of the force Ns1′ and the component F41,
F44 represents the component of the reaction force F43 in the direction A′,
F45 represents the friction force generated by the component F44 and the friction coefficient μ1,
F46 represents the component of the friction force F45 in the direction B, and
F47 represents the friction force generated by the force Ns1′ and the friction coefficient μ3.
This is expressed by FB>FE (formula 1), where

FB=F47=μ3Ns1′, and

FE=F42=N1 sin θ1.

Since the left side is equal to 13.8 (N) and the right side is equal to 0.51 (N), it is understood that formula 1 is satisfied. Specifically, it is understood that the charging roller 2Y is moved in the direction B from the state in which the charging roller 2Y is separated from the cleaning roller 8Y.

If the relationship between the angles θ1 and θ3 satisfies (θ1+1) (degrees)≤θ3≤(θ1+5) (degrees), it is possible to separate the charging roller 2Y from the cleaning roller 8Y as appropriate.

In the present exemplary embodiment, suitable ranges of the angles θ1 and θ2 and the friction coefficients μ1, μ2, and μ3 are as follows,

0 (degrees)<θ1≤50 (degrees),
10 (degrees)≤θ2≤60 (degrees),
0.6≤μ1≤2.5,
0.1≤μ2≤0.5, and
0.01≤μ3≤0.5.

The force N1, N2, Ns1, and Ns2 considered at this time are within the following ranges,

### 1.47 (N)≤N1≤2.45 (N),

### 0.98 (N)≤N1≤1.96 (N),

### 2.94 (N)≤Ns1≤6.37 (N), and

### 1.18 (N)≤Ns2≤2.45 (N).

As described above, while the photosensitive drum 1Y in the present exemplary embodiment is rotated in the positive direction, the charging roller 2Y is located in the first position, and while the photosensitive drum 1Y is stopped, the charging roller 2Y and the cleaning roller 8Y are separated from each other. Specifically, while the photosensitive drum 1Y is stopped, the charging roller 2Y is in the first position due to the rotation of the photosensitive drum 1Y in the positive direction.

### <Operation Check>

The operations in the first exemplary embodiment were checked. When the photosensitive drum 1Y was rotated, the charging roller 2Y was located in the first position. Further, when the photosensitive drum 1Y was stopped, the charging roller 2Y was moved in the direction E by about 3.2 mm, separated from the cleaning roller 8Y by about 1.4 mm, and located in the second position. Further, when the photosensitive drum 1Y was rotated in a state in which the charging roller 2Y was located in the second position, the charging roller 2Y was moved to the first position.

The configuration according to the first exemplary embodiment makes it possible to bring a charging roller into contact with a charging roller cleaning member and separate the charging roller from the charging roller cleaning member by a simplified structure without a dedicated driving source.

A second exemplary embodiment will be described below. In the first exemplary embodiment, the configuration is described in which the charging roller 2Y is moved from the first position to the second position due to gravity in association of the stop of the photosensitive drum 1Y.

### <Control of Rotation of Photosensitive Drum>

In the second exemplary embodiment, the control unit 303 is capable of rotating the photosensitive drum 1Y in a direction opposite to the positive rotation direction (rotation direction C), which is the rotation direction in image forming, by reversing the rotation direction of the driving source 300. A configuration will be described below in which the photosensitive drum 1Y is configured to be rotatable in the positive rotation direction, which is the rotation direction in image forming, and in the opposite direction to the positive rotation direction, and the photosensitive drum 1Y is rotated in the opposite direction to move the charging roller 2Y from the first position to the second position.

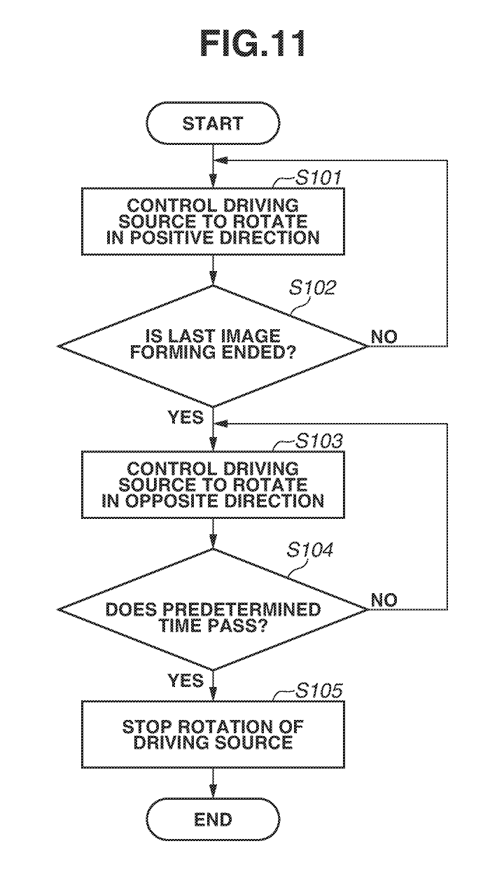

FIG. 11 is a flowchart illustrating a process of control in image forming in the second exemplary embodiment.

In step S101, as the image forming is started, the control unit 303 controls the driving source 300 such that the photosensitive drum is rotated in the positive direction.

Next, in step S102, the control unit 303 determines whether the last image forming is ended. If the control unit 303 determines that the last image forming is ended (YES in step S102), the processing proceeds to step S103. On the other hand, if the control unit 303 determines that the last image forming is not ended (NO in step S102), the processing returns to step S101.

If the control unit 303 determines that the last image forming is ended (YES in step S102), then in step S103, the control unit 303 controls the driving source 300 such that the photosensitive drum is rotated in the opposite direction.

Next, in step S104, the control unit 303 determines whether a predetermined time has passed from the start of the rotation in the opposite direction. If the control unit 303 determines that the predetermined time has passed from the start of the rotation in the opposite direction (YES in step S104), the processing proceeds to step S105. On the other hand, if the control unit 303 determines that the predetermined time has not passed from the start of the rotation in the opposite direction (NO in step S104), the processing returns to step S103.

If the control unit 303 determines that the predetermined time has passed from the start of the rotation in the opposite direction (YES in step S104), then in step S105, the rotation of the driving source 300 is stopped.

### <Configuration of Second Exemplary Embodiment>

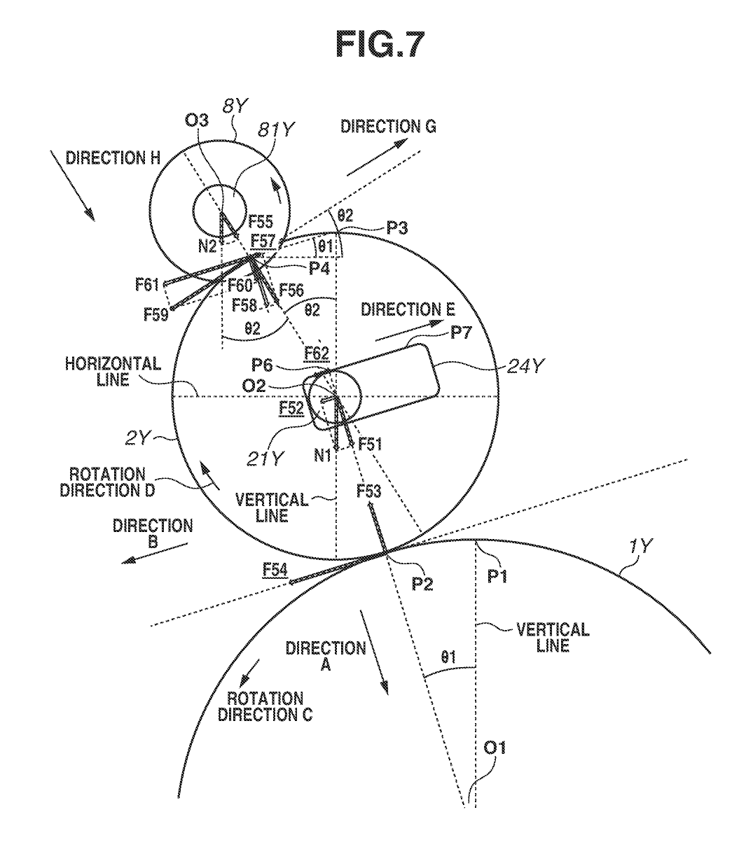

FIGS. 7 to 9 illustrate a configuration of the second exemplary embodiment. The angle θ1 in FIG. 4 in the first exemplary embodiment is the angle obtained when the point P2 is moved to the point P1 by rotating the photosensitive drum 1Y in the opposite direction to the rotation direction of the photosensitive drum 1Y in image forming. On the other hand, the angle θ1 in FIG. 7 in the second exemplary embodiment is the angle obtained when the point P2 is moved to the point P1 by rotating the photosensitive drum 1Y in the rotation direction thereof in image forming. The configurations of the first and second exemplary embodiments differs from each other in this point.

Further, in the second exemplary embodiment, the position of the charging roller 2Y is movable from the first position to the second position even if the second position is located above the first position in the vertical direction. However, even in the case of the configuration in FIG. 4 in which the position of the charging roller 2Y is movable from the first position to the second position by gravity alone (the case in which the angle θ1 in FIG. 7 is negative), it is possible to reliably separate the charging roller 2Y from the cleaning roller 8Y by rotating the photosensitive drum 1Y in the opposite direction. Accordingly, the configuration illustrated in FIG. 4 is also encompassed within the second exemplary embodiment.

Further, while FIG. 7 illustrates the configuration in which the direction E is orthogonal to the direction A as in the first exemplary embodiment, the configuration is not limited to the above-described condition as in the first exemplary embodiment.

In the second exemplary embodiment, the diameter of the outer circumferential surface of the charging roller 2Y is 14 (mm), the diameter of the outer circumferential surface of the cleaning roller 8Y is 11 (mm), and the diameter of the outer circumferential surface of the photosensitive drum 1Y is 30 (mm).

Further, the force N1 generated due to the mass of the charging roller 2Y is N1=1.96 (N), the force N2 generated due to the mass of the cleaning roller for cleaning the charging roller 2Y is N2=0.98 (N), the angle θ1=40 (degrees), and the angle θ2=50 (degrees).

The angle θ3 formed by the gravity direction and the direction extending from the rotation center of the charging roller 2Y toward the rotation center of the photosensitive drum 1Y in the state in which the charging roller 2Y and the cleaning roller 8Y are separated from each other is θ3=35 (degrees).

Further, the friction coefficient μ1 of the charging roller 2Y and the photosensitive drum 1Y is μ1=2.0, and the friction coefficient μ2 of the charging roller 2Y and the cleaning roller 8Y is μ2=0.3.

The force Ns1 of the spring 22Y which is applied to the charging roller 2Y is Ns1=4.9 (N), the contact force Ns2 from the cleaning roller 8Y to the charging roller 2Y is Ns2=2.35 (N), and the force Ns1′ received by the charging roller 2Y from the spring 22Y while the charging roller 2Y and the cleaning roller 8Y are separated from each other is Ns1′=4.41 (N).

The distance between the rotation center of the charging roller 2Y and the rotation center of the cleaning roller for cleaning the charging roller 2Y is 12.5 (mm).

<Force Applied to Charging Roller in Charging Position while Photosensitive Drum is Rotated in Positive Direction>

Next, force applied to the charging roller 2Y in the charging position while the photosensitive drum 1Y is rotated in the positive direction will be described below with reference to FIG. 7.

In FIG. 7,

F51 represents the component of the force N1 in the direction A,
F52 represents the component of the force N1 in the direction E,
F53 represents the reaction force of the resultant force of the force Ns1 and the components F51, F58, and F60,
F54 represents the friction force generated by the reaction force F53 and the friction coefficient μ1,
F55 represents the component of the force N2 in the direction H,
F56 represents the resultant force of the component F55 and the pressing force Ns2,
F57 represents the component of the resultant force F56 in the direction E,
F58 represents the component of the resultant force F56 in the direction A,
F59 represents the friction force generated by the resultant force F56 and the friction coefficient μ2,
F60 represents the component of the friction force F59 in the direction A,
F61 represents the component of the friction force F59 in the direction B, and
F62 represents the friction force generated by the force Ns1 and the friction coefficient μ3.

As in the first exemplary embodiment, the force FB in the direction B needs to be greater than the force FE in the direction E to locate the charging roller 2Y in the first position. This can be expressed by the following formula:

FB>FE (formula 1).

FB=N1 sin θ1+μ2(N2 cos θ2+Ns2)cos(θ2−θ1)+μ1(Ns1+N1 cos θ1+μ2(N2 cos θ2+Ns2)sin(θ2−θ1)+(Ns2+N2 cos θ2)cos(θ2−θ1))+μ3×Ns1, and

FE=(Ns2+N2 cos θ2)sin(θ2−θ1).

Accordingly,

N1 sin θ1+μ2(N2 cos θ2+Ns2)cos(θ2−θ1)+μ1(Ns1+N1 cos θ1+μ2(N2 cos θ2+Ns2)sin(θ2−θ1)+(Ns2+N2 cos θ2)cos(θ2−θ1))+μ3×Ns1>(Ns2+N2 cos θ2)sin(θ2−θ1)

needs to be satisfied.

Since the left side is equal to 19.7 (N) and the right side is equal to 0.52 (N), it is understood that the condition of formula (1) is satisfied.

### <Force Applied to Charging Roller in Charging Position While Photosensitive Drum is Rotated in Opposite Direction>

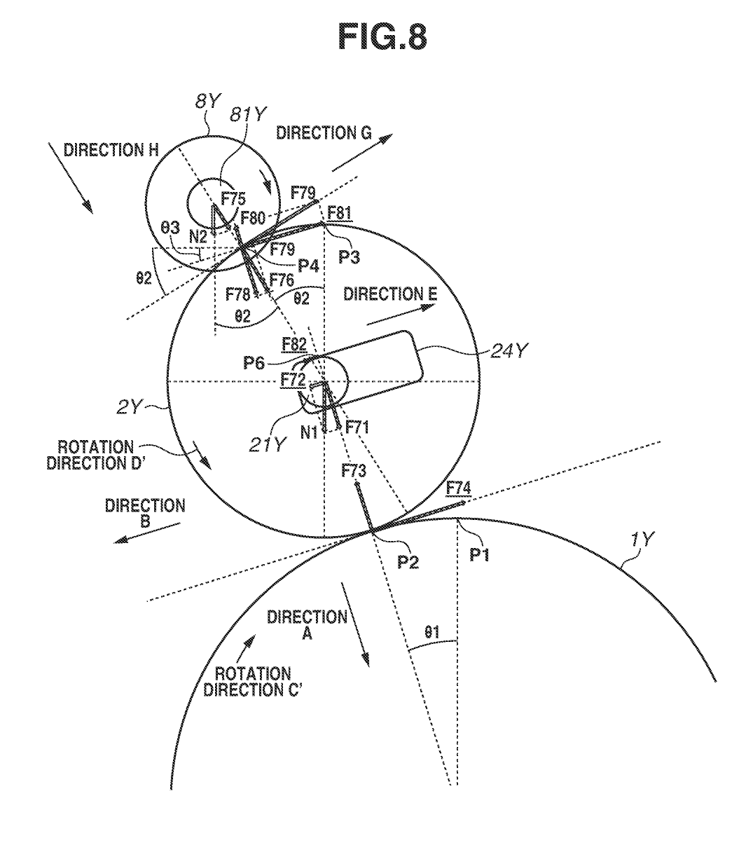

Next, force applied to the charging roller 2Y in the charging position while the photosensitive drum 1Y is rotated in the opposite direction will be described below with reference to FIG. 8.

In FIG. 8,

F71 represents the component of the force N1 in the direction A,
F72 represents the component of the force N1 in the direction E,
F73 represents the reaction force of the resultant force of the force Ns1 and the components F71, F78, and F80,
F74 represents the friction force generated by the reaction force F73 and the friction coefficient μ1,
F75 represents the component of the force N2 in the direction H,
F76 represents the resultant force of the component F75 and the pressing force Ns2,
F77 represents the component of the resultant force F76 in the direction E,
F78 represents the component of the resultant force F76 in the direction A,
F79 represents the friction force generated by the resultant force F76 and the friction coefficient μ2,
F80 represents the component of the resultant force F79 in the direction A,
F81 represents the component of the resultant force F79 in the direction E, and
F82 represents the friction force generated by the force Ns and the friction coefficient μ3.

The force FE needs to be greater than the force FB to locate the charging roller 2Y in the second position. Further, it is assumed Ns1>Ns1′ for simplification. This is expressed by the following formula:

FE>FB (formula 2).

The photosensitive drum 1Y is rotated in the opposite direction to apply a driving force to the photosensitive drum 1Y so that the charging roller 2Y is separated from the cleaning roller 8Y.

FE=μ2(N2 cos θ2+Ns2)cos(θ2−θ1)+μ1(Ns1+N1 cos θ1+(Ns2+N2 cos θ2)cos(θ2−θ1)−(Ns2+N2 cos θ2)sin(θ2−θ1)), and

FB=N1 sin θ1+μ3Ns1+(Ns2+N2 cos θ2)sin(θ2−θ1).

Since the left side of formula (2) is 21.2 (N) and the right side of formula (2) is 3.6 (N), it is understood that formula (2) is satisfied.

Accordingly, the photosensitive drum 1Y in the present exemplary embodiment is rotated in the opposite direction to separate the charging roller 2Y from the cleaning roller 8Y.

The photosensitive drum 1Y is rotated in the opposite direction such that the charging roller 2Y is moved in the circumferential direction by about 2.6 mm along the outer circumferential surface of the photosensitive drum 1Y.

The movement by about 2.6 mm did not cause problems in cleaning. It should be noted, however, that if the amount of rotation in the opposite direction is large, a lubricant agent contained in an external additive of the toner at a nip portion of the cleaning blade decreases. Thus, the next rotation in the positive direction can cause curling of the cleaning blade and/or generate vibration sounds. A suitable amount of movement in the opposite direction is about 2 mm to about 15 mm.

### <Force Applied to Charging Roller in Retracted Position While Photosensitive Drum is Rotated in Positive Direction>

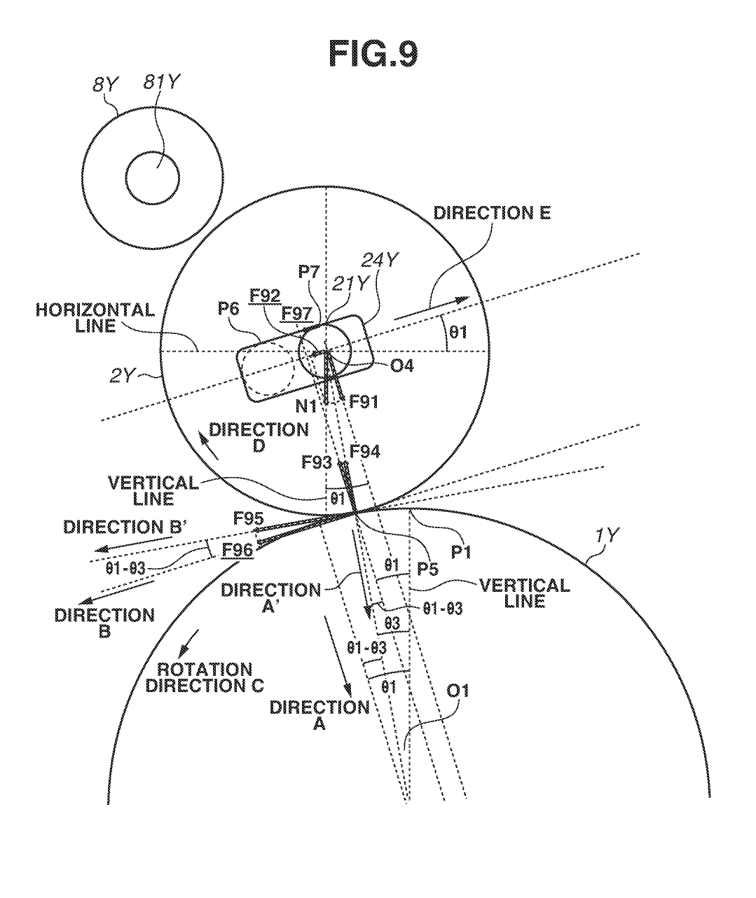

Next, force applied to the charging roller 2Y in the retracted position while the photosensitive drum 1Y is rotated in the positive direction will be described below with reference to FIG. 9. As in the first exemplary embodiment, the force FE needs to be greater than the force FB to move the charging roller 2Y from the second position to the first position.

In FIG. 9,

F91 represents the component of the force N1 in the direction A,
F92 represents the component of the force N1 in the direction E,
F93 represents the reaction force of the resultant force of the force Ns1′ and the component F41,
F94 represents the component of the reaction force F43 in the direction A′,
F95 represents the friction force generated by the component F94 and the friction coefficient μ1,
F96 represents the component of the friction force F95 in the direction B, and
F97 represents the friction force generated by the force Ns1′ and the friction coefficient μ3.

This can be expressed by the following formula:

FE>FB (formula 1).

FE=N1 sin θ1+μ1 cos(θ1−θ3)cos(θ1−θ3)(N1 cos θ1+Ns1′)+μ3×Ns1′, and

FB=0.

Since the left side is equal to 13.0 (N) and the right side is equal to 0 (N), formula 1 is satisfied. Specifically, it is understood that the charging roller 2Y is movable to the first position by rotating the photosensitive drum 1Y in the positive direction when the charging roller 2Y is in the second position.

If the relationship between the angles θ1 and θ3 satisfies (θ3+1) (degrees)≤θ1≤(θ3+5) (degrees), it is possible to separate the charging roller 2Y from the cleaning roller 8Y as appropriate.

In the present exemplary embodiment, suitable ranges of the angles θ1 and θ2 and the friction coefficients μ1, μ2, and μ3 are

−75 (degrees)≤θ1≤75 (degrees),
0 (degrees)≤θ2≤75 (degrees),
0.6≤μ1≤2.5,
0.1≤μ2≤0.5, and
0.01≤μ3≤0.5.

The force N1, N2, Ns1, and Ns2 considered at this time are within the following ranges,

### 1.47 (N)≤N1≤2.45 (N),

### 0.98 (N)≤N1≤1.96 (N),

### 2.94 (N)≤Ns1≤6.37 (N), and

### 1.18 (N)≤Ns2≤2.45 (N).

As described above, in the case in which the photosensitive drum 1Y is rotated in the positive direction in the present exemplary embodiment, the charging roller 2Y is located in the first position.

Further, in the case in which the photosensitive drum 1Y is rotated in the opposite direction, the charging roller 2Y is located in the second position.

Further, the charging roller 2Y located in the second position is movable to the first position by rotating the photosensitive drum 1Y in the positive direction.

### <Operation Check>

The operations in the second exemplary embodiment were checked. When the photosensitive drum 1Y was rotated in the positive direction, the charging roller 2Y was located in the first position. Further, when the photosensitive drum 1Y was rotated in the opposite direction, the charging roller 2Y was moved in the direction E by about 3.2 mm, separated from the cleaning roller 8Y by about 1.4 mm, and located in the second position. Further, when the photosensitive drum 1Y was rotated in the positive direction in a state where the charging roller 2Y is located in the second position, the charging roller 2Y was moved to the first position.

As described above, a space-saving image forming apparatus with reduced cost can be realized by a simple structure, even without a dedicated driving source, that enables the charging roller 2Y and the cleaning roller for cleaning the charging roller 2Y to be brought into contact with and separated from each other.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2017-161729, filed Aug. 25, 2017, and No. 2018-107033, filed Jun. 4, 2018, which are hereby incorporated by reference herein in their entirety.

What is claimed is:

1. An image forming apparatus comprising:
a photosensitive drum which is rotatable;
a driving source which rotates the photosensitive drum;
a charging roller which includes a rotation shaft, is brought into contact with the photosensitive drum to be rotated in association with rotation of the photosensitive drum, and charges the photosensitive drum as a voltage is applied;
a cleaning roller which is brought into contact with the charging roller to be rotated in association with rotation of the charging roller and cleans a substance attached to the charging roller;
an image forming unit which forms an image by forming a toner image on the photosensitive drum charged by the charging roller and transferring the toner image onto a recording material;
a bearing member which has a space in which the rotation shaft is movable, and bears the rotation shaft on an inner circumferential surface of the space, wherein the space allows the charging roller to be moved to a first position in which the charging roller is in contact with the cleaning roller and the photosensitive drum and a second position in which the charging roller is separated from the cleaning roller and is in contact with the photosensitive drum, the area including an inner surface which bears the rotation shaft; and
a biasing member which biases the bearing member toward the photosensitive drum.

2. The image forming apparatus according to claim 1, wherein the cleaning roller includes a cleaning roller rotation shaft, and the bearing member rotatably bears the cleaning roller rotation shaft.

3. The image forming apparatus according to claim 1,
wherein part of the inner circumferential surface of the space includes a contacted portion with which the rotation shaft is brought into contact, and
wherein the charging roller is rotated in association with the rotation of the photosensitive drum and the rotation shaft is brought into contact with the portion-to-be-contacted so that the charging roller is located in the first position.

4. The image forming apparatus according to claim 1, wherein the inner circumferential surface of the area forms an elongated hole shape when viewed from an axial direction of the rotation shaft.

5. The image forming apparatus according to claim 1, wherein a point P2 is located in a position of a point P1 rotated by an angle θ1 in an opposite rotation direction to a rotation direction of the photosensitive drum, a point P4 is located in a position of a point P3 rotated by an angle θ2 in an opposite rotation direction to a rotation direction of the charging roller, and
0 (degrees)<θ1≤50 (degrees) and
10 (degrees)≤θ2≤60 (degrees)
are satisfied, where when viewed from an axial direction of the rotation shaft, O1 denotes a rotation center of the photosensitive drum, O2 denotes a rotation center of the charging roller when the charging roller is in the first position, O3 denotes a rotation center of the cleaning roller, the point P1 is a point, from among points at which a vertical line passing through the rotation center O1 intersects with an outer circumferential surface of the photosensitive drum, that lies on an upper side in a vertical direction, the point P2 is a point at which a straight line connecting the rotation centers O1 and O2 intersects with the outer circumferential surface of the photosensitive drum, the point P3 is a point, from among points at which a vertical line passing through the rotation center O2 intersects with an outer circumferential surface of the charging roller, that lies on an upper side in the vertical direction, and the point P4 is a point at which a straight line connecting the rotation centers O2 and O3 intersects with the outer circumferential surface of the charging roller when the charging roller is in the first position.

6. The image forming apparatus according to claim 5, wherein a straight line connecting points P6 and P7 is orthogonal to the straight line connecting the rotation centers O1 and O2, where the point P6 is a point on a biasing member side of the inner circumferential surface of the space with which the rotation shaft is in contact when the charging roller is in the first position, and the point P7 is a point on the biasing member side of the inner circumferential surface of the space with which the rotation shaft is in contact when the charging roller is in the second position.

7. The image forming apparatus according to claim 5, wherein a direction in which the biasing member biases the bearing is parallel to the straight line connecting the rotation centers O1 and O2.

8. The image forming apparatus according to claim 5, wherein a point P5 is located in a position of the point P1 rotated by an angle θ3 in the opposite rotation direction to the rotation direction of the photosensitive drum, and
(θ1+1) (degrees)≤θ3≤(θ1+5) (degrees)
is satisfied, where when viewed from the axial direction of the rotation shaft, O4 denotes a rotation center of the charging roller when the charging roller is in the second position, and the point P5 is a point at which a straight line connecting the rotation centers O1 and O4 intersects with the outer circumferential surface of the photosensitive drum.

9. The image forming apparatus according to claim 5, wherein a coefficient of friction μ between an outer circumferential surface of the rotation shaft and the inner circumferential surface of the space satisfies:
0.01≤μ≤0.5.

10. The image forming apparatus according to claim 1,
wherein the driving source is capable of rotating the photosensitive drum in a positive direction which is a rotation direction in image forming and in an opposite direction which is an opposite rotation direction to the positive direction, and
wherein a point P2 is located in a position of a point P1 rotated by an angle θ1 in the rotation direction of the photosensitive drum in the positive direction, a point P4 is located in a position of a point P3 rotated by an angle θ2 in an opposite rotation direction to a rotation direction of the charging roller in association with the rotation of the photosensitive drum in the positive direction, and
−75 (degrees)≤θ1≤75 (degrees) and
0 (degrees)≤θ2≤75 (degrees)
are satisfied, where when viewed from an axial direction of the rotation shaft, O1 denotes a rotation center of the photosensitive drum, O2 denotes a rotation center of the charging roller when the charging roller is in the first position, O3 denotes a rotation center of the cleaning roller, the point P1 is a point, from among points at which a vertical line passing through the rotation center O1 intersects with an outer circumferential surface of the photosensitive drum, that lies on an upper side in a vertical direction, the point P2 is a point at which a straight line connecting the rotation centers O1 and O2 intersects with the outer circumferential surface of the photosensitive drum, the point P3 is a point, from among points at which a vertical line passing through the rotation center O2 intersects with an outer surface of the charging roller, that lies on an upper side in the vertical direction, and the point P4 is a point at which a straight line connecting the rotation centers O2 and O3 intersects with the outer circumferential surface of the charging roller when the charging roller is in the first position.

11. The image forming apparatus according to claim 10, wherein a straight line connecting points P6 and P7 is orthogonal to the straight line connecting the rotation centers O1 and O2, where the point P6 is a point on a biasing member side of the inner circumferential surface of the space with which the rotation shaft is in contact when the charging roller is in the first position, and the point P7 is a point on the biasing member side of the inner circumferential surface of the space with which the rotation shaft is in contact when the charging roller is in the second position.

12. The image forming apparatus according to claim 10, wherein a direction in which the biasing member biases the bearing is parallel to the straight line connecting the rotation centers O1 and O2.

13. The image forming apparatus according to claim 10, wherein a point P5 is located in a position of the point P1 rotated by an angle θ3 in the rotation direction of the photosensitive drum, and
(θ3+1) (degrees)≤θ1≤(θ3+5) (degrees)
is satisfied, where when viewed from the axial direction of the rotation shaft, O4 denotes a rotation center of the charging roller when the charging roller is in the second position, and the point P5 is a point at which a straight line connecting the rotation centers O1 and O4 intersects with the outer circumferential surface of the photosensitive drum.

14. The image forming apparatus according to claim 10, wherein a coefficient of friction μ between an outer circumferential surface of the rotation shaft and the inner circumferential surface of the space satisfies:
0.01≤μ≤0.5.
